(19) United States
(12) Patent Application Publication
(10) Pub. No.: US 2013/0066699 A1
(43) Pub. Date: Mar. 14, 2013

(54) SYSTEMS AND METHODS FOR PROVISIONING REBATE INSTRUMENTS

(71) Applicant: Christopher Quinlan, Wilmington, DE (US)

(72) Inventor: Christopher Quinlan, Wilmington, DE (US)

(73) Assignee: The Ohana Companies, Inc., Wilmington, DE (US)

(21) Appl. No.: 13/604,359

(22) Filed: Sep. 5, 2012

Related U.S. Application Data
(60) Provisional application No. 61/533,182, filed on Sep. 9, 2011.

(51) Int. Cl. G06Q 30/02

(52) U.S. Cl. 705/14.17

(57) ABSTRACT

A promotional rewards system processes data from transactions with consumers, some of which qualify for rebates. Qualified rebates are remitted to the consumer through a first value instrument, such as a widely accepted debit card account. The consumer can expend the rebate according to terms of use of the first value instrument issuer, typically in incremental amounts within a maximum period of time. Upon reaching an expiration date, or by another process such as when reaching a minimum balance or when requested by the consumer, at least part of a residual value associated with the account of the first value instrument issuer is applied to issue a second value instrument that can have different and potentially more restrictive terms of use, such as an in-store value card or a discount coupon. In this way, the residual value and its promotional effect are not lost.

### CROSS REFERENCE TO RELATED APPLICATION

This application claims the priority of U.S. provisional application Ser. No. 61/533,182, filed Sep. 9, 2011.

### FIELD OF THE INVENTION

This disclosure relates to the provisioning and management of product marketing reward or rebate instruments.

### BACKGROUND OF THE INVENTION

Values or sums that are accorded to customers as rewards or incentives can be provided in any of various particular forms of account, such as user authorizations, user cards, cash or discounts and coupons against future purchases, among other examples. One form of rebate system supplies customers who qualify for a rebate with prepaid debit cards associated with accounts managed through banking networks. Such cards and accounts can be useful at any merchant that honors such cards and accounts, the sums deducted from the cards or accounts being effectively converted to legal tender upon presentation for a payment at almost any merchant.

Another form of rebate account is restricted, for example, to use at selected establishments such as the different stores of a given business (such as a retailer who issued the card), or for purchase of a limited set of items that are associated with the issuer (such as the manufacturer of the product qualifying for the rebate and other products that the manufacturer seeks to promote).

Still other forms of rebates are not associated with accounts that are individual to the customer, such as discount coupons that the bearer presents at the point of sale to obtain a reduction in a purchase price.

These forms of rebate, promotion, discount and the like typically have terms including expiration dates, in addition to any restrictions on where the indicia can be presented or the nature of a transaction with which the rebate, promotion or discount can be used. Restrictions on use and expirations reduce the value realized by the customer and reduce the loyalty-inducing promotional effect achieved by the promotional program.

Commercial businesses are constantly looking for ways to retain and increase client base. Product marketing rebates are well-known to most consumers and have been used by manufacturers as a tool for promoting and selling products by providing customers with an incentive to purchase particular products. In a typical rebate system, a consumer will purchase a product and subsequently submit a rebate claim for that product along with identifying information, such as the consumer's name, address, telephone number, e-mail address, etc. The rebate redemption process typically relies on a cash register receipt showing where and when the item was purchased, and sometimes on the Universal Product Code (UPC) or other designated portion of the product packaging to show that the product was actually consumed. Additionally, the redemption process can involve cross referencing point of sale data and rebate qualification terms, to confirm that the particular consumer and transaction qualify for the rebate.

On receipt of the rebate claim and consumer identifying information, the manufacturer, or an agent of the manufacturer, such as a rebate processing service, will verify by data processing steps that the transaction occurred as claimed, and transfer the value of the rebate to the consumer. Thus, the consumer is provided with an incentive to purchase products having rebate offers.

The rebate may be in the form of cash value. In the past, the rebate value was frequently transferred by sending the consumer a check in the amount of the rebate. Recently, commercial businesses have transferred rebate values by providing re-usable rebate instruments, for example rebate cards, or loyalty cards. To receive the value of a re-usable rebate instrument such as a check, a consumer submits a rebate claim as before. However, rather than receiving a check, the consumer receives a debit card.

The debit card is said to be preloaded with the amount of the rebate. Although it may be possible for the debit card to store or to bear an indicia that represents the remaining value on the card, typically the card has a magnetic strip or RFID element that stores an account identification code. The value loaded on the card and the value remaining on the card are stored in a banking system database accessed over a data communication network using the account identification code and optionally other security information such as an encryption code, personal identification number or the like.

A rebate instrument such as a debit card may be characterized as ‘open loop’ or ‘closed loop’. An open loop rebate instrument is typically associated with or serviced by a banking network and may be valid for presentation anywhere where a major credit or debit card is accepted. A closed loop rebate instrument may be used at a more limited number of locations, such as certain companies, business types, manufacturers, localities or at participating retailers.

Re-usable rebate instruments such as rebate cards are a convenient way for consumers to realize the value of a purchase incentive. However, rebate cards have some drawbacks for consumers. In some cases it is difficult for a consumer to realize the full amount of a rebate value loading onto card's associated account. For example, rebate cards may be loaded only once and then depleted by one or several successive transactions in each of which a part of the loaded value is used and deducted away. Such cards and accounts often have expiration dates that allow only limited time for consumers to use them. Once such a rebate instrument expires it is no longer redeemable at any location.

Even when a consumer attempts to expend the account value associated with a card before the expiration date, the card may expire with some residual value remaining unspent. In some typical rebate purchase situations, the card applies to purchases that are equal to or less than the amount remaining on the card. In other situations the consumer may find it inconvenient to attempt to use up the residual sum in a card account together with cash or other credits. It may be difficult or inconvenient to expend an amount equal to the total value that was originally credited as the rebate value. There is a high likelihood that some value will remain on a card at the time of expiration. With typical rebate instruments, the consumer forfeits this value at expiration.

With some rebate and card accounts, the consumer does not get around to using any of the rebate amount. The rebate card is left in a drawer or pocket and discovered again after the rebate period has expired. Although the card issuer may obtain some promotional benefit when the card is issued, the consumer comes to understand that rebate cards, gift cards and similar card accounts are less valuable than cash in hand in an equal amount. This situation reduces the promotional effect of card accounts.

There is a need for systems and methods that preserve residual value of prepaid rebate instruments for the benefit of the consumer. Further, there is a need for systems and methods that maximize the promotional value of the rebate program for the issuing commercial business while providing the aforementioned benefit to the consumer. However, it is not practical to require the banking network indefinitely to retain an account that may have a small residual value, and may have been forgotten or associated with a lost card that will never be presented again. Accordingly, the present disclosure provides systems and methods for delivering rebates on flexible instruments that adapt the rebate instrument over time, such as by converting an open loop account that has expired into a closed loop account or an indicia that qualifies for a particular merchant or merchandise discount. This technique preserves the benefit of the rebate to the consumer, maximizes the promotional return of a rebate program for merchants, and does not require the maintenance of secure accounts over unreasonably long periods of time.

### SUMMARY OF THE INVENTION

It is an aspect of this disclosure that reward or incentive values applied in the customer's favor in a rebate or promotional effort, preferably applied initially to an account form that is relatively more openly useful and unrestricted, is shifted to a different form according to procedures such as rules for expiration after a term of months or years. Instead of a rebate account expiring and its residual value escheating to the issuer (or its full value if never used), the rebate account continues to carry a value that the consumer can exploit, albeit in a manner that can be managed with less accounting and data processing overhead.

An object is fully to accomplish the issuer's promotional goals by retaining value to the customers and thus obtaining associated customer loyalty and respect, compared to the conventional situation of forfeiture or escheat of unexpended balances after a term. Another object is to reduce the overhead of managing residual amounts in rebate accounts, by providing for conversion into other forms such as loyalty rewards, discount coupons and similar indicia. Such conversion advantageously is used as an opportunity to provide the consumer with a reminder that such value is being retained, with additional promotional benefit to the issuer.

### DESCRIPTION OF THE DRAWINGS

These and other objects, features and advantages of the invention will be apparent from a consideration of the following detailed description of the invention considered in conjunction with the drawing figures, in which:

FIG. 1 is a block diagram of a system for provisioning rebate instruments according to an embodiment of the invention;

FIG. 2 is a flowchart illustrating steps of a method for provisioning rebate instruments;

FIG. 3 is a flowchart illustrating a generalized embodiment.

FIG. 4 is a flowchart showing steps in converting any remainder in a credited rebate account to an alternative form upon expiration of an issued account type.

FIG. 5 is a flowchart more specifically showing converting a credited open loop rebate account to a closed loop account upon expiration.

### DETAILED DESCRIPTION

In accordance with the present invention, there are provided herein methods and systems for provisioning instruments that are issued to represent and provide access to a value that has been awarded to a consumer, especially as part of a promotional process. That value thereafter is applied as remittance in one or more transactions. In various embodiments, advantageous systems and methods apply the subject matter to providing rebate instruments to consumers, at least initially linked to cash accounts. Rebate instruments include any debit or credit instrument, including Visa®, MasterCard®, Discover®, American Express®, or other credit card, loyalty card, smartcard, scannable device, or other card or device suitable for storing information relating to a rebate instrument or rebate offer and/or providing access to an expendable account stored in a banking network or the like.

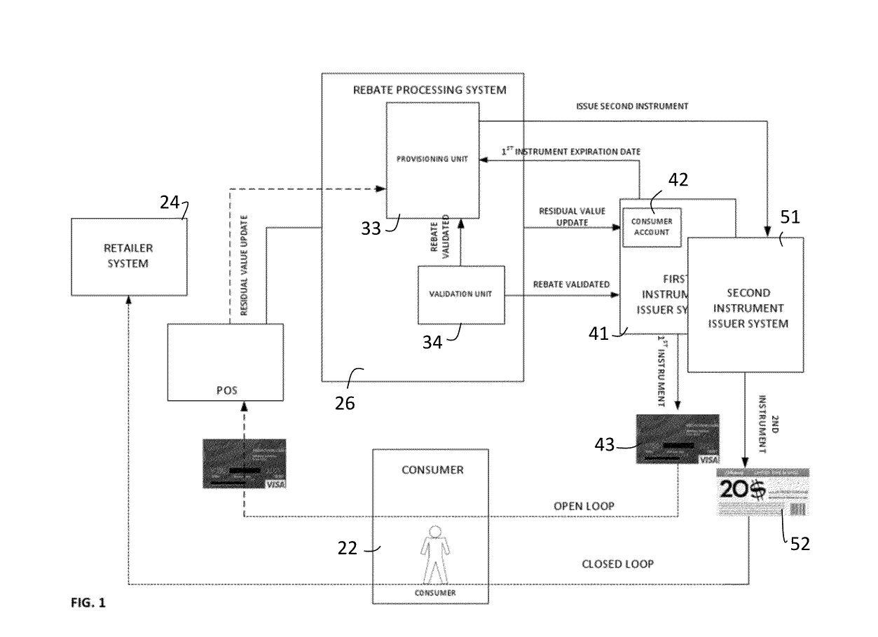

In the example of provisioning rebate cards or indicia as shown in FIG. 1, there are several entities involved, including the consumer 22, a retailer 24, a rebate processing system 26, and two instrument-issuing payment networks 27, 28. The consumer 22 qualifies for a rebate by meeting the requirements that retailer 24 or perhaps an associated manufacturer or other interested party imposes. The rebate may be associated with a transaction involving a sale at a point of sale terminal POS coupled to the retailer's computer network. By network data communications and/or by supplying appropriate application forms for the consumer to submit, the rules and conditions for the consumer to qualify for a rebate and to apply for the rebate are established and made known to the consumer 22 and the rebate processing system 26.

The rebate processing system 26 includes a rebate provisioning unit 33 and a validation unit 34. When a consumer qualifies for a rebate according to the rules and conditions, the rebate processing system 26 communicates over data processing networks with at least a first instrument issuer system 41, namely a banking or financial system, which establishes a consumer account 42 representing a value from which remittances can be deducted. The account can have an associated user card 43 that the user can present at point of sale terminals such as the POS terminal of the retailer 24. Advantageously, there are few if any limitations on how the consumer can spend the balance of the consumer account associated with the first instrument 43, although the system is applicable to limited usage accounts as well.

However according to one aspect, the rules and conditions concerning the rebate system (or at least the user account 42 at the first instrument issuer 41) include provisions by which the account 42 and the instrument 43 will terminate. The instrument 43 may have a termination date or maximum lifetime, and/or a minimum balance may be required in a re-usable refillable arrangement, or similar limitations may apply. Rather than simply terminating the account 42 according to those limitations, when the account and instrument expire or become exhausted to some level or otherwise are due for expiration, the system triggers a second instrument issuer system to issue to the consumer 22 a second instrument 52. The second instrument advantageously does not have the full range of remittance capabilities of the first instrument and may be limited to use only at the original retailer's premises of to purchase the original rebate promoter's goods and services. For example, the second instrument may not have an associated account and my simply represent a cash-off coupon, a discount coupon or a customer loyalty card.

The retailer or merchant system 24 may provide a rebate offer to consumers in relation to a specified purchase that is being promoted. A rebate processor system validates rebate claims from the consumers and provides information relating to the claims to a financial system 41. The financial system issues a first rebate instrument 43 to a consumer based on the information received from the rebate processing system 26. The financial system may fulfill the rebate payment obligations upon consumer use of the first rebate instrument, e.g., to cash out and close the account, to decrement the account in the amount of purchase, or even deliberately to choose that the account value be applied to produce a second instrument whose value may be appealing to the consumer for some reason.

### Rebate Offer

The merchant 24 may offer the rebate to consumers and may be the promotional backer or may be participating in a rebate program of a manufacturer or wholesaler who backs the promotional system. In some embodiments, the merchant notifies the consumer of the rebate offer when a purchase is made. Typically, notification may be a written or oral communication indicating the terms of the rebate offer and instructing consumers with regard to satisfaction of the rebate offer. For example, consumers may be notified by a mass distributed flyer or advertisement. Such notifications may appear within printed or electronic media such as newspapers, magazines, journals and the like, internet publications or other internet websites, or any other advertising medium. Additionally, the notifications may be in the form of an email or delivered mail. Other forms of notification, such as oral communication or radio and television advertisements, are contemplated to be within the scope of the present invention. In some embodiments, consumers do not learn of the rebate offer until after entering a merchant's physical or internet location.

A rebate offer may be made upon completion of a qualifying purchase. In that case, a qualifying purchase may comprise a transaction recorded by a point-of-sale data processing and storage system. Typical point-of-sale data processing and storage systems may comprise a computerized system that receives purchase data either by manual entry by an operator or through scanning a Universal Product Code (“UPC”) supplied on the product packaging by either the merchant system or the manufacturer. Often, the recording for each qualified purchase may include a transaction identifier or unique identification number (“UIN”). In one embodiment, the UIN may also be recorded on a receipt issued to the consumer.

The receipt may be issued to the consumer directly, in the case of an in-store purchase, or electronically transferred from a merchant system to a consumer system, in the case of an electronic purchase. An electronic receipt may be in the form of a transfer across a computer network, such as the internet. The point-of-sale data processing and storage system may be any system known in the art for recording and processing purchases at the point of sale. In some embodiments, the rebate processing system receives reports from the point-of-sale data processing and storage systems. The reports may comprise a plurality of purchase data records, e.g., information relating to the sales transactions including purchase price of each product purchased, etc.

### Rebate Redemption

### Rebate Processing System

The consumer may submit a rebate claim to the rebate processing system 26 without the involvement of the retailer. Advantageously, however, the retailer is involved at least to the extent that the rebate processing system can verify that a rebate-qualifying transaction reported by the consumer actually did occur in the amount stated. Alternatively, the rebate processing system may rely on the documentation provided, e.g., filled-in rebate application, original sales receipt, particular piece of product packaging, etc. A rebate claim may comprise the submission by the consumer of a rebate claim form. The consumer may submit the rebate claim by mail, telephone, internet, or any other suitable means for submitting a rebate claim.

A rebate claim form may generally request transaction information, including the UIN, and selected portions of consumer information. Additionally, a rebate claim form may include a destination address, rebate promotion information, and instructions for submitting material verifying the qualifying purchase, if necessary or desired. Consumer information may comprise any information that identifies or is associated with a particular consumer, such as the consumer's name, address, phone number, e-mail address, etc.

In some cases, the consumer may not be aware of the involvement of a rebate processing system and may submit the rebate claim to the merchant system, e.g., by addressing the rebate claim to the merchant, electronically submitting the rebate claim at the merchant's internet website, etc. The merchant system may then forward the rebate claim to the rebate processing system.

The rebate processing system may, among other rebate processing activities, validate the request for redemption from the consumer. The rebate processing system may employ a variety of rebate processing and validation systems and methods. Hardware and software components used by the rebate processing system may be integral portions of a single computer or server or may be connected parts of a computer network. The hardware and software components may be located within the rebate processing system or may be operated offsite by a third-party subcontractor. In other embodiments, portions of the hardware and software components may be divided among a plurality of locations and connected directly or through a global computer information network, such as the internet.

The rebate processing system notifies a financial system of a rebate request. The rebate processing system may provide the information from a rebate claim with an order or request for the financial system to issue a pre-paid rebate card. The information may be provided separately from an order or request for the financial system to issue a pre-paid rebate card. For example, the rebate processing system may place an order for a predetermined amount of pre-paid rebate cards for which the rebate processing system may later provide information that the financial system can use to issue the pre-paid rebate cards. In other words, the rebate processing system may preorder a bulk amount of pre-paid rebate cards for which the rebate processing system will subsequently provide information relating to which consumers the financial system should issue pre-paid rebate cards.

### Financial System

The financial system 41 may subsequently issue a first rebate instrument 43. In one embodiment of the invention the first rebate instrument comprises a pre-paid rebate instrument to the consumer. The pre-paid rebate instrument may be issued using any of a variety of media including, but not limited to plastic cards, paper coupons and electronic coupons. In one embodiment, the prepaid rebate instrument is a plastic debit card. The consumer may then use the pre-paid card in accordance with its terms. In one embodiment of the invention, a rebate card is configured to implement terms of a three-party agreement between a merchant system, a rebate processing system, and a financial system.

In a further embodiment, the financial system may also print the pre-paid rebate cards. That is, the financial institute may imprint the necessary data, such as the consumers name and a unique card number, on the pre-paid rebate cards. In some embodiments, the financial system may issue the pre-paid rebate cards directly to the consumers. The information the financial system may use to issue the pre-paid rebate cards directly to the consumers (e.g., consumer names, addresses, etc.) may be provided with the information received from the rebate processing system. In further embodiments, the financial system may be a federal bank.

### First Rebate Instrument

First rebate instruments 43 can comprise ‘open loop’ rebate instruments, or ‘closed loop’ rebate instruments. An open loop instrument allows the consumer to use the rebate instrument at generally any location that accepts payment by credit or debit card, respectively, namely at most points of purchase and sale. Pre-paid rebate instruments may alternatively comprise ‘closed loop’ rebate instruments. Closed loop rebate instruments allow the consumer to use the instrument only at restricted locations such as the premises of the initial merchant system where the consumer made a purchase the qualified for the rebate, or for a restricted range of purchases, such as products and services of a sponsoring manufacturer or products and services that are associated with the original purchase such as maintenance services, consumable supplies, etc.

The financial system provides the consumer with a first rebate instrument. A first rebate instrument in accordance with an embodiment of the present invention may include any debit or credit card, including Visa®, Mastercard®, Discover®, American Express®, or other credit card, loyalty card, smartcard, scannable device, or other card or device suitable for storing information relating to a pre-paid rebate card or rebate offer. In some embodiments, the pre-paid rebate card may be a pre-paid credit card.

After receipt of the first rebate instrument 43, e.g., a pre-paid rebate card, the consumer 22 may use the pre-paid rebate card to purchase goods or services. In one embodiment of the invention, the first rebate instrument is an ‘open loop’ instrument. That is, the first rebate instrument may be used at any merchant system that accepts payment by that instrument. For example the instrument may be a credit or debit card usable at any merchant system that accepts such cards, including the merchant system that offered the initial rebate or other outside merchant system. In some embodiments, the consumer may use the pre-paid rebate card a plurality of times until the value of the prepaid rebate card has been substantially or completely exhausted. For example, the consumer may make multiple transactions at multiple locations using the same pre-paid rebate card.

The pre-paid rebate card may be, or may be similar to, a credit card, such that the pre-paid rebate card may be swiped in a credit card scanning device at the time of purchase and the pre-paid rebate card information may be automatically entered into the point-of-sale data processing and storage system. Alternatively, the pre-paid rebate card may contain a unique number, such as a credit card number, that an operator may manually enter into the point-of-sale data processing and storage system. In one embodiment, the pre-paid card is reloadable. In other embodiments, the pre-paid card is not reloadable. In still other embodiments, the pre-paid card is reloadable but only in connection with future rebates associated with one or more of the same merchant, manufacturer, sponsor or financial system.

The consumer 22 may make multiple transactions at multiple locations using the first instrument 43 much like a credit or debit card. In some embodiments, before the consumer may use the pre-paid rebate card, the pre-paid rebate card may require activation by the consumer. In some embodiments, the consumer may activate the pre-paid rebate card by telephone or electronically over the internet.

The transactions made using the first rebate instrument are recorded and the amount of the user account 42 remaining for remittance using the instrument is updated after each purchase. In one embodiment of the invention, transaction data is provided to the issuing financial system. The issuing financial system updates the value remaining on the first financial instrument accordingly. In one embodiment of the invention, the financial system provides an updated remaining value to a provisioning system of a rebate processing system.

### Provisioning System

In one embodiment, the provisioning system 33 of the rebate processing system 26 receives or produces information related to terms applicable to the first rebate instrument. For example the provisioning system receives an expiration period or expiration date associated with the first rebate instrument. The provisioning system may also receive information related to the pre-loaded value of the first rebate instrument. The provisioning system determines a date to be associated with an expiration warning based on the information it receives about the expiration date. An expiration warning is a signal indicating that the first financial instrument is near its expiration date. In one embodiment of the invention, the expiration warning is set for a date that is a predetermined number of days in advance of the expiration date of the first financial instrument.

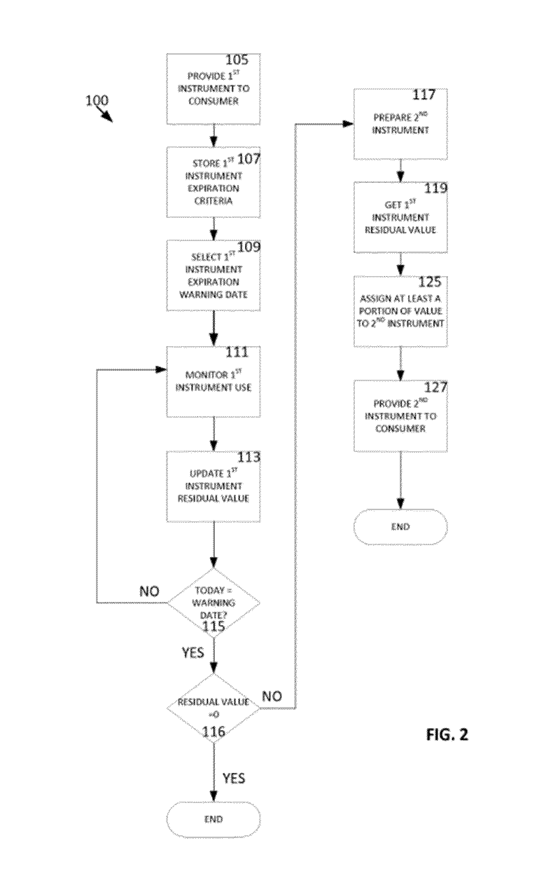

On the date associated with the expiration warning, the provisioning system initiates a process that provides a second rebate instrument to the consumer. This process 100 is illustrated in FIG. 2 by steps 105 through 127. If, on the date associated with the expiration warning, the residual value (the value remaining) of the first financial instrument is not zero, at least a portion of the nonzero residual value is assigned to a second rebate instrument.

In one embodiment of the invention, the second rebate instrument is a closed loop instrument. That is, the second rebate instrument is usable only at a limited number of locations or sites. In some embodiments, the second rebate instrument is limited to use with the merchant associated with the rebate offer.

The consumer may then redeem the second rebate instrument, thereby avoiding forfeiture of the residual value of the first rebate instrument.

The table below shows examples of suitable first rebate instruments and corresponding suitable second rebate instruments. The examples are not intended to be exhaustive of the possible combinations of first and second rebate instruments. Thus a provisioning method according to one embodiment of the invention transforms a first rebate processing instrument to a second rebate processing instrument.

TABLE I

FIRST REBATE PROCESSING INSTRUMENT
Open-Loop Prepaid Single-Load Plastic Card
Open-Loop Prepaid Single-Load Plastic Card
Open-Loop Prepaid Single-Load Virtual Card
Open-Loop Prepaid Single-Load Virtual Card
Open-Loop Prepaid Single-Load Plastic Card
Open-Loop Prepaid Single-Load Plastic Card
Open-Loop Prepaid Single-Load Virtual Card
Open-Loop Prepaid Reloadable Virtual Card
Open-Loop Prepaid Reloadable Plastic Card
Open-Loop Prepaid Reloadable Plastic Card
Open-Loop Prepaid Reloadable Virtual Card
Open-Loop Prepaid Reloadable Virtual Card
Check
Check
Check
Check
Check
Check
Check
Check
Check
Check
SECOND REBATE PROCESSING INSTRUMENT
Closed-Loop Prepaid Single-Load Plastic Gift Card
Closed-Loop Prepaid Single-Load Virtual Gift Card
Closed-Loop Prepaid Single-Load Plastic Gift Card
Closed-Loop Prepaid Single-Load Virtual Gift Card
Closed-Loop Prepaid Reloadable Plastic Gift Card
Closed-Loop Prepaid Reloadable Virtual Gift Card
Closed-Loop Prepaid Reloadable Plastic Gift Card
Closed-Loop Prepaid Reloadable Virtual Gift Card
Closed-Loop Prepaid Single-Load Plastic Gift Card
Closed-Loop Prepaid Single-Load Virtual Gift Card
Closed-Loop Prepaid Single-Load Plastic Gift Card
Closed-Loop Prepaid Single-Load Virtual Gift Card
Closed-Loop Prepaid Single-Load Plastic Gift Card
Closed-Loop Prepaid Single-Load Virtual Gift Card
Closed-Loop Prepaid Single-Load Plastic Gift Card
Closed-Loop Prepaid Single-Load Virtual Gift Card
Closed-Loop Prepaid Reloadable Plastic Gift Card
Closed-Loop Prepaid Single-Load Virtual Gift Card
Closed-Loop Prepaid Reloadable Plastic Gift Card
Closed-Loop Prepaid Reloadable Virtual Gift Card
Coupon
Reward Points

The system as described is capable of a number of variations but in general forms a promotional rewards system comprising a rebate processing system 26 configured to process data defining transactions with consumers 22, certain of which transactions qualify for promotional rebates according to criteria applied by the rebate processing system in approving grants of rebates for at least one of particular transactions and particular rebate values. A first value instrument issuer system 41 is in data communication with the rebate processing system 26, and produces a first account indicia 43 representing a value 42 credited to a respective one of said consumers in connection with a rebate that is approved by the rebate processing system. The value credited to the consumer is available to be expended by the consumer according to a first redemption process having first terms of use. At least one second value instrument issuer system 51 is in data communication with at least one of the rebate processing system 26 and the first value instrument issuer system 41. At least a residual value associated with the first account indicia 42, 43 is expendable by transfer from the first value instrument issuer system 41 to the second value instrument issuer system 51 so as to produce a second account indicia 52 representing a value credited to the consumer and available according to a second redemption process having second terms of use that differ from the first and for example can be more restricted. The second redemption process can be designed to bring the consumer back to the retailer where the consumer originally entered a transaction qualifying for the rebate.

The first terms of use can include termination after one of a maximum lifetime and at an expiration date for the first account indicia, and the promotional awards system can automatically transfer at least a portion of the residual value to the second value instrument issuer system in connection with said termination. Instead or in addition to expiration after a time limit, the account can have an associated minimum balance that must be used or the account will be closed.

The second terms of use can be more restrictive than the first terms of use as to at least one of a range of establishments at which the second indicia is honored, and a range of products at which the second redemption process can be expended. Preferably, however, the first account indicia comprises a widely accepted open loop user account measured in currency and from the consumer's standpoint useful in the same ways as a bank credit or debit card. Thus, the first account indicia can be associated with one of a credit and debit banking account system as one of a virtual account and a user card account. The second account indicia comprises one of single establishment debit account card, a discount coupon for a stated sum, a discount coupon for a stated percentage, and a rewards card entitling a consumer to promotional advantages.

The transfer from the first value instrument issuer system to the second value instrument issuer system can be initiated automatically at one of expiration of the first account indicia according to the first terms of use, or upon request of the consumer prior to said expiration.

For promotional and operational reasons, the relative redemption values of the first and second indicia, and the terms of their use, can vary widely. For example, the face value of the second account indicia may be less than the face value or residual value of the first account indicia, by an amount accounting for one of a transfer fee and a deflation of value associated with expiration of the first account indicia. Alternatively, the face value of the second indicia may be high, but its use restricted to particular purchases such as high value purchases from the sponsoring retailer. In a typical embodiment, the second terms of use have one of a face value and a scope of said second terms of redemption that is less favorable to the consumer than the first terms of use and the first redemption process.

The first and second account indicia each can comprise any of a variety of instruments. In exemplary embodiments, the indicia can be single balance carrying accounts, reloadable accounts, open loop accepted payment indicia, closed loop accepted payment indicia, physical user cards with associated accounts, virtual user card accounts, credit accounts, debit accounts, value coupons, percentage discount coupons, user rewards cards carrying entitlement to selected promotional specials and/or indicia representing currency.

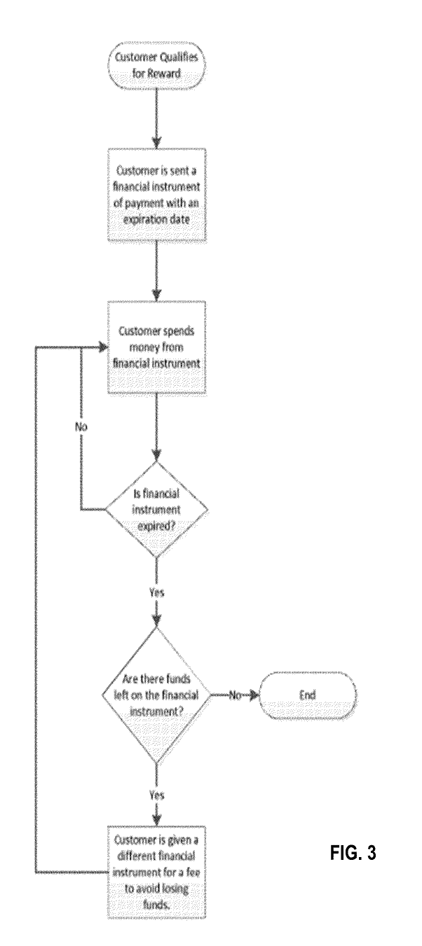

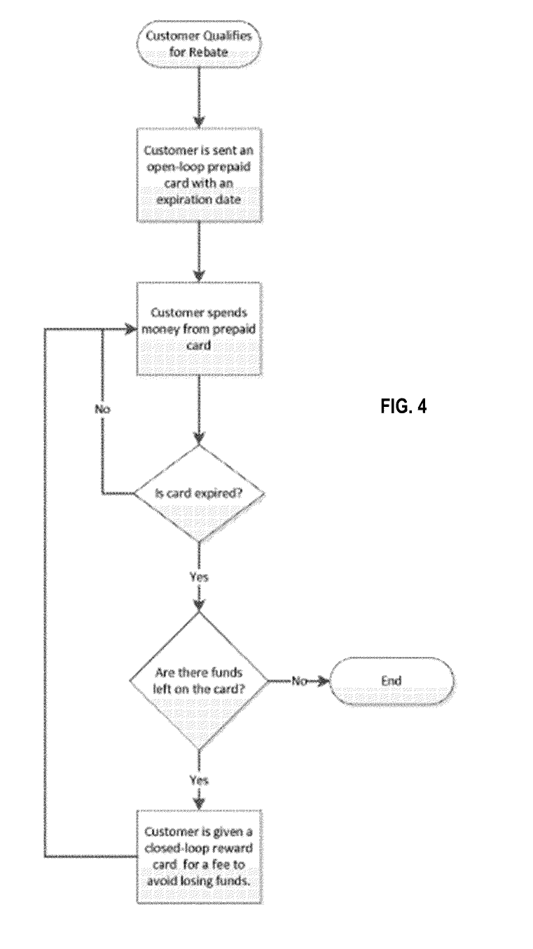

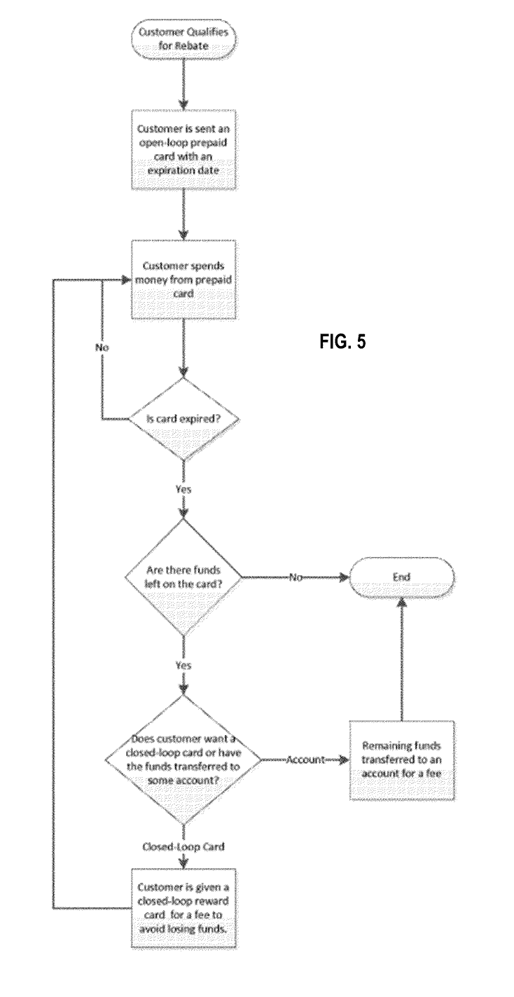

In addition to being a particular arrangement of networked processes and entities (consumer, retailer, rebate processing system and two distinct account issuers), the present subject matter provides a computerized method for manipulating user card accounts for promotional purposes. FIG. 3 shows a generalized embodiment in flowchart method form. FIG. 4 shows steps in converting a remainder in a credited rebate account to an alternative form upon expiration of an issued account type. FIG. 5 more specifically shows converting a credited open loop rebate account to a closed loop account upon expiration.

The method includes awarding a consumer 22 with a value credit in connection with at least one of a rebate, a gift certificate transaction, a purchase transaction and a refund, and issuing to the consumer a physical indicia 43 associated with a stored value initially equal to the value credit, the stored value being represented by one of data carried by the indicia and data stored in a remote account that is associated with the indicia and accessible over a computer network. Such issuing is accomplished according to terms that include conditions upon which the indicia representing the value shall terminate.

The indicia is presented and accepted in transactions to remit all or part of an amount due, up to the stored value. The stored value is decremented by data communications over the computer network, leaving a residual value associated with the indicia. Upon termination of the indicia by one of depletion of the stored value, termination according to the conditions and request by the consumer. A different physical indicia granted to the consumer. This can include applying at least a portion of the residual value at the time of expiration to issuing to the consumer a different physical indicia representing a promotional benefit to the consumer. Alternatively, a promotional benefit can be generated solely because the first indicia has expired or its account value used up.

The physical indicia advantageously comprises an account card for making payments in an open loop remittance network and the different physical indicia comprises an authorization in a closed loop remittance network. The different indicia is chosen from the group consisting of single balance carrying accounts, reloadable accounts, physical user cards with associated accounts, virtual user card accounts, credit accounts, debit accounts, value coupons, percentage discount coupons, user rewards cards carrying entitlement to selected promotional specials, and indicia representing currency. The different physical indicia can be provided with limited authorization, e.g., as remittance for purchases only at a limited subset of all retailers for purchasing a limited subset of products and services from any retailer or only from the subset. The different physical indicia can be as strong as a cash rebate on particular purchases or a price reduction by an amount or percentage. Or the different indicia can be as weak as a customer loyalty card by which loyal customers bearing a card can qualify for shopping benefits such as in-store promotional discounts.

The subject matter has been disclosed and exemplified by particular embodiments, but is not limited only to the examples that are specifically mentioned and illustrated. Reference should be made to the following claims as opposed to the foregoing examples, to assess the scope of the invention in which exclusive rights are claimed.

What is claimed is:

1. A promotional rewards system, comprising:
a rebate processing system configured to process data defining transactions with consumers, certain of which transactions qualify for promotional rebates according to criteria applied by the rebate processing system in approving grants of rebates for at least one of particular transactions and particular rebate values;
a first value instrument issuer system in data communication with the rebate processing system, wherein the first value instrument issuer system produces a first account indicia representing a value credited to a respective one of said consumers in connection with a rebate that is approved by the rebate processing system;
wherein the value credited to said consumer is available to be expended by the consumer according to a first redemption process having first terms of use;
at least one second value instrument issuer system in data communication with at least one of the rebate processing system and the first value instrument issuer system, wherein at least a residual value associated with the first account indicia is expendable by transfer from the first value instrument issuer system to the second value instrument issuer system so as to produce a second account indicia representing a value credited to the consumer and available according to a second redemption process having second terms of use.

2. The promotional rewards system of claim 1, wherein the first terms of use include termination after one of a maximum lifetime and at an expiration date for the first account indicia, and wherein the promotional awards system automatically transfers at least a portion of the residual value to the second value instrument issuer system in connection with said termination.

3. The promotional rewards system of claim 2, wherein the second terms of use are more restrictive than the first terms of use as to at least one of a range of establishments, and a range of products at which the second redemption process can be expended.

4. The promotional rewards system of claim 3, wherein the first account indicia comprises a widely accepted open loop user account measured in currency and the second account indicia comprises a closed loop indicia redeemable at a limited range of establishments.

5. The promotional rewards system of claim 3, wherein the first account indicia is associated with one of a credit and debit banking account system having one of a virtual account and a user card account.

6. The promotional rewards system of claim 3, wherein the second account indicia comprises one of single establishment debit account card, a discount coupon for a stated sum, a discount coupon for a stated percentage, and a rewards card entitling a consumer to promotional advantages.

7. The promotional rewards system of claim 1, wherein the transfer from the first value instrument issuer system to the second value instrument issuer system is initiated at one of expiration of the first account indicia according to the first terms of use, and request of the consumer prior to said expiration.

8. The promotional rewards system of claim 1, wherein a face value of the second account indicia is less than a face value of the first account indicia, by an amount accounting for one of a transfer fee and a deflation of

9. The promotional rewards system of claim 1, wherein the second terms of use have one of a face value and a scope of said second terms of redemption that is less favorable to the consumer than the first terms of use and the first redemption process.

10. The promotional rewards system of claim 1, wherein the first and second account indicia are selected from the group consisting of single balance carrying accounts, reloadable accounts, open loop accepted payment indicia, closed loop accepted payment indicia, physical user cards with associated accounts, virtual user card accounts, credit accounts, debit accounts, value coupons, percentage discount coupons, user rewards cards carrying entitlement to selected promotional specials, and indicia representing currency.

11. A computerized method for manipulating user card accounts for promotional purposes, comprising the steps of:
awarding a consumer with a value credit in connection with at least one of a rebate, a gift certificate transaction, a purchase transaction and a refund;
issuing to the consumer a physical indicia associated with a stored value initially equal to the value credit, the stored value being represented by one of data carried by the indicia and data stored in a remote account that is associated with the indicia and accessible over a computer network;
wherein said issuing is accomplished according to terms that include conditions upon which the indicia representing the value shall terminate;
accepting the indicia in a transaction to remit an amount due less than the stored value, and decrementing the stored value by the amount due over the computer network, leaving a residual value associated with the indicia;
upon termination of the indicia by one of depletion of the stored value, at least a portion of the residual value for issuing to the consumer a different physical indicia representing a promotional benefit to the consumer.

12. The computerized method of claim 11, wherein the physical indicia comprises an account card for making payments in an open loop remittance network and the different physical indicia comprises an authorization in a closed loop remittance network.

13. The computerized method of claim 12, wherein the different physical indicia is chosen from the group consisting of single balance carrying accounts, reloadable accounts, physical user cards with associated accounts, virtual user card accounts, credit accounts, debit accounts, value coupons, percentage discount coupons, user rewards cards carrying entitlement to selected promotional specials, and indicia representing currency.

14. The computerized method of claim 13, wherein the different physical indicia is accepted by a limited subset of retailers.

15. The computerized method of claim 13, wherein the different physical indicia is accepted for remittance on purchase of a limited subset of products and services.

16. The computerized method of claim 13, wherein the different physical indicia entitles a bearer to a shopping benefit.
